(19) United States
(12) Patent Application Publication
(10) Pub. No.: US 2009/0195116 A1
(43) Pub. Date: Aug. 6, 2009

(54) MOTOR STATOR STRUCTURE

(76) Inventor: Borgan PONG, Taichung County (TW)

Correspondence Address: Joe McKinney Muncy, PO Box 1364, Fairfax, VA, 22038-1364, US

(21) Appl. No.: 11/969,757

(22) Filed: Jan. 4, 2008

(51) Int. Cl. H02K 5/15; H02K 1/12; H02K 15/16; H02K 1/18

(52) U.S. Cl. 310/216.129; 310/270

(57) ABSTRACT

The present invention discloses an improved motor stator structure, which comprises: a plurality of silicon steel plates, two rotor bearing blocks, and a plurality of pins. In the present invention, the pins are forced to pass through the through-holes of the silicon steel plates and then inserted into the buried holes to make the end faces of the pins closely contact the motor rotor bearing blocks. Thereby, the silicon steel plates and the rotor bearing blocks are concentrically assembled together. As all the pins has an identical length and closely contact the rotor bearing blocks, the rotor bearing blocks are parallel to each other and vertical to the stacking direction of the silicon steel plates. Thus, the present invention is an easy-to-fabricate motor stator structure, which has a considerable precision and a lower fabrication cost.

### FIELD OF THE INVENTION

The present invention relates to a motor stator, particularly to a motor stator structure.

### BACKGROUND OF THE INVENTION

Refer to FIG. 1 for a conventional motor stator structure. The conventional motor stator structure comprises: a stator 1 and a rotor 2. The stability and efficiency of motor operation correlates closely with the assembly precision of the stator 1 and the rotor 2. The conventional stator 1 includes a plurality of silicon steel plates 3. The silicon steel plates 3 are clamped by two assembly boards 4A and 4B from two sides thereof and then fastened by a plurality of screws 5. The assembly boards 4A and 4B have positioning grooves 6A and 6B, which are fabricated with a machining method and used to precisely locate rotor bearing blocks 7A and 7B. Then, the rotor 1 is sleeved inside the rotor bearing blocks 7A and 7B and the stator 1. Thus is completed the assembly of the stator 1 and the rotor 2.

In the conventional motor stator structure, the screws 5 pass through holes 3A of the silicon steel plates 3 and fasten the silicon steel plates 3 to the assembly boards 4A and 4B. As the screws 5 do not closely fit the holes 3A of the silicon steel plates 3, the silicon steel plates 3 need aligning neatly to ensure the concentricity of the stacked silicon steel plates 3. To ensure the concentricity of the positioning grooves 6A and 6B and the stacked silicon steel plates 3, the assembly boards 4A and 4B should be lathed together with the stacked silicon steel plates 3. Such a process needs a special fixture and a large-size lathe, which results in fabrication difficulties and a high cost.

### SUMMARY OF THE INVENTION

The primary objective of the present invention is to provide an easy-to-fabricate and cost-efficient motor stator structure having a considerable precision.

To achieve the abovementioned objective, the present invention proposes an improved motor stator structure, which comprises: a plurality of silicon steel plates, two rotor bearing blocks, and a plurality of pins. The silicon steel plates have a plurality of through-holes along the rims thereof and are assembled together to form a stack. The two rotor bearing blocks are respectively arranged at two side of the stack of the silicon steel plates and have buried holes corresponding to the through-holes of the silicon steel plates. The pins have an identical length. The pins have a diameter exactly identical to that of the through-holes of the silicon steel plates so that the pins can tightly fit the through-holes of the silicon steel plates. Thus, the pins are forced to pass through the silicon steel plates to make all the silicon steel plates neatly and concentrically arranged. Then, the pins are inserted into the buried holes to closely contact the rotor bearing blocks.

The present invention uses the pins to tightly secure the silicon steel plates and the rotor bearing blocks so that they can be concentrically assembled. As all the pins, which closely contact the rotor bearing blocks, have an identical length, the two rotor bearing blocks are parallel to each other and vertical to the stacking direction of the silicon steel plates. Compared with the conventional technologies, the present invention is an easy-to-fabricate motor stator structure, which has a lower fabrication cost and can satisfy users.

### BRIEF DESCRIPTION OF THE DRAWINGS

FIG. 1 is a diagram schematically showing a conventional motor stator structure,

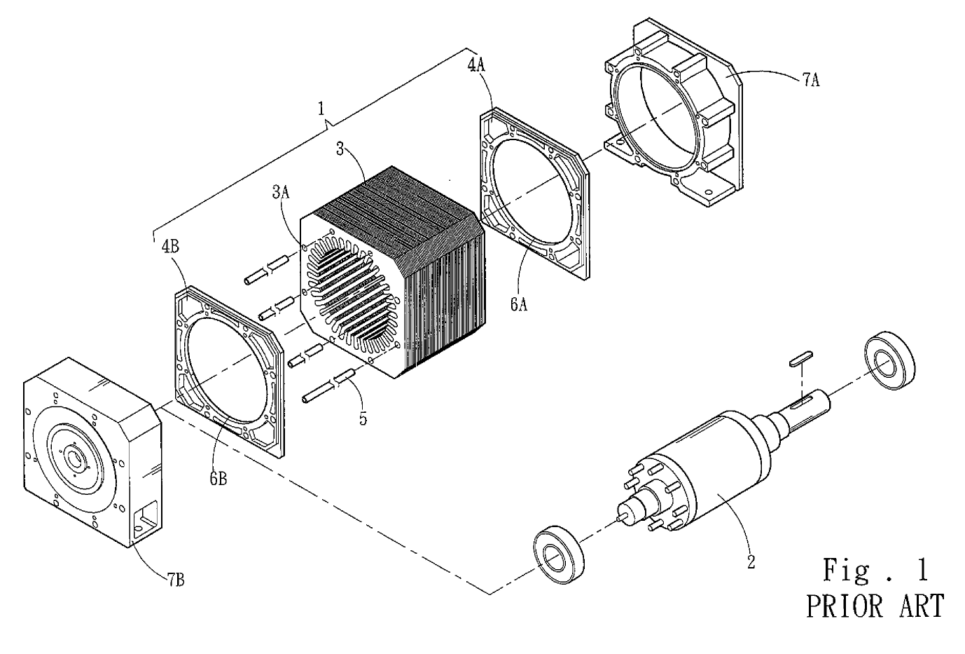

FIG. 2 is an exploded view of a motor stator structure according to the present invention.

FIG. 3 is an assembly drawing of a motor stator structure according to the present invention.

FIG. 4 is a partial sectional view of a motor stator structure according to the present invention.

### DETAILED DESCRIPTION OF THE PREFERRED EMBODIMENTS

Below, the preferred embodiments are described in cooperation with the drawings to make easily understand the objectives, characteristics, and efficacies of the present invention.

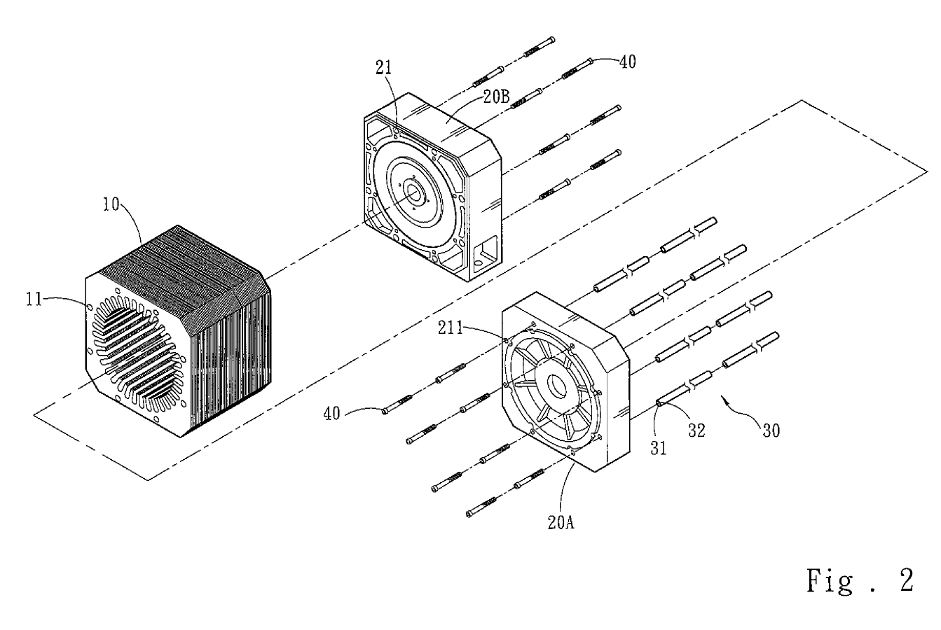

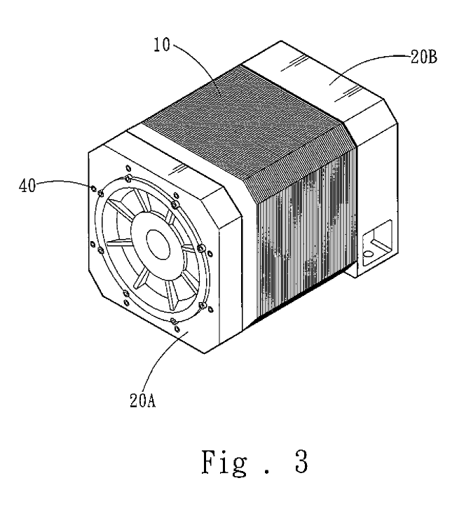

Refer to FIG. 2 and FIG. 3. The present invention comprises: a plurality of silicon steel plates 10, two rotor bearing blocks 20A and 20B, and a plurality of pins 30. The silicon steel plate 10 has a plurality of through-holes 11 along the rim thereof, and the through-holes 11 are uniformly distributed. The number of the through-holes 11 is determined by the customer. In the drawings, the silicon steel plate 10 has eight through-holes 11, However, the present invention is not limited by the drawings. The silicon steel plates 10 are assembled together to form a stack, and the two rotor bearing blocks 20A and 20B are respectively arranged at two sides of the stack of the silicon steel plates 10. The rotor bearing blocks 20A and 20B have buried holes 21 corresponding to the through-holes 11 of the silicon steel plates 10. The pins 30 have an identical length. The pins 30 have a diameter exactly identical to that of the through-holes 11 of the silicon steel plates 10 so that the pins 30 can tightly fit the through-holes 11 of the silicon steel plates 10.

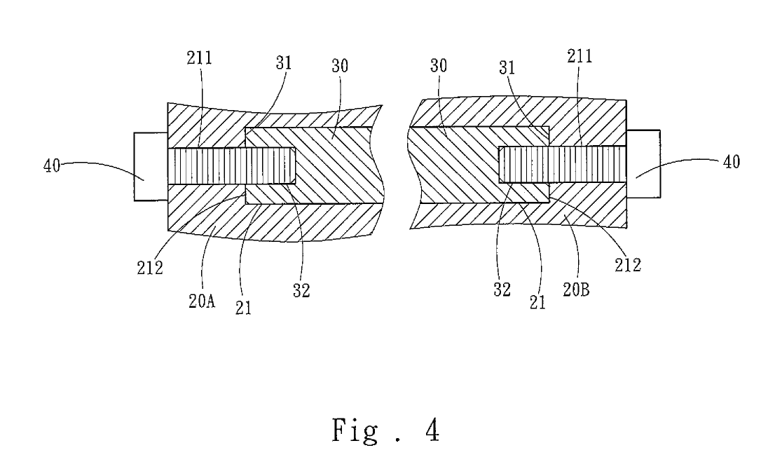

In the present invention, the pins 30 are forced to pass through the through-holes 11 of the silicon steel plates 10 and then inserted into the buried holes 21 to closely contact the motor rotor bearing blocks 20A and 20B. Refer to FIG. 4. The pin 30 has end faces 31 vertical to the pin 30, and each end face 31 has a threaded hole 32. The bottom face 212 of the buried hole 21 is also a vertical plane and has a through-hole 211. A screw 40 is inserted through the through-hole 211 and screwed into the threaded hole 32 to make the end face 31 of the pin 30 closely contact the bottom face 212 of the buried hole 21. Thereby, the pins 30, the silicon steel plates 10 and the motor rotor bearing blocks 20A and 20B are secured in a relative position.

As mentioned above, the pins 30 are forced to pass through the through-holes 11 of the silicon steel plates 10 and then inserted into the buried holes 21 of the motor rotor bearing blocks 20A and 20B. Thereby, the motor rotor bearing blocks 20A and 20B and the silicon steel plates 10 can be concentrically assembled together. As all the pins 30 have an identical length, and as the end faces 31 of the pins 30 closely contact the motor rotor bearing blocks 20A and 20B, the motor rotor bearing blocks 20A and 20B are parallel to each other and vertical to the stacking direction of the silicon steel plates 10. Therefore, the present invention is an easy-to-fabricate motor stator structure, which can reduce the fabrication cost and satisfy users.

What is claimed is:

1. An improved motor stator structure comprising:
a plurality of silicon steel plates stacked together and having a plurality of through-holes along the rim thereof;
two motor rotor bearing blocks arranged at two sides of said silicon steel plates and having buried holes corresponding to said through-holes of said silicon steel plates; and
a plurality of pins having an identical length, having a diameter exactly identical to that of said through-holes of said silicon steel plates, and forced to pass through said through-holes of said silicon steel plates and then inserted into said buried holes to closely contact said motor rotor bearing blocks.

2. The improved motor stator structure according to claim 1, wherein said pins have two end faces vertical to said pins, and each end face has a threaded hole; bottom faces of said buried holes are also vertical planes and have through-holes; screws are inserted through said through-holes and screwed into said threaded holes to make said end faces of said pins closely contact said bottom faces of said buried holes and to secure said pins, said silicon steel plates and said motor rotor bearing blocks in a relative position.

3. The improved motor stator structure according to claim 1, wherein said through-holes of said silicon steel plates are uniformly distributed.
